(19) United States
(12) Patent Application Publication
(10) Pub. No.: US 2005/0075745 A1
(43) Pub. Date: Apr. 7, 2005

(54) System and method of disseminating recorded audio information

(76) Inventor: Richard Fitzgerald, Brighton (AU)

Correspondence Address: The Halvorson Law Firm, Ste 130, 1757 E. Baseline, Gilbert, AZ, 85233, US

(21) Appl. No.: 10/837,436

(22) Filed: Apr. 30, 2004

Related U.S. Application Data
(63) Continuation of application No. PCT/AU02/01470, filed on Oct. 31, 2002.

(30) Foreign Application Priority Data
Oct. 31, 2001 (AU) PR 8601

(51) Int. Cl. H04M 1/64

(52) U.S. Cl. 700/94

(57) ABSTRACT

A method of disseminating recorded information (e.g. a press release) spoken by a first person, including the steps of: a) recording at least audio information at a first location, thereby creating recorded information; b) generating a bibliographic tag which is associated with the recorded information and includes an identifier; c) transmitting the recorded information and the bibliographic tag to a second location; and d) storing the recorded information and the bibliographic tag at said second location for selective access by further persons from respective further locations. The bibliographic tag can include a condition access means substantially determining a condition which upon being fulfilled allows selective access. The condition could include: a time after which selective access is to be allowed; and authorization of any editing of the information on behalf of the first person; a geographical limitation on the further locations from which further persons can obtain selective access; or an authorization of the further persons to obtain selective access.

This application is a continuation of pending PCT application Ser. No. PCT/AU02/01470 filed on Oct. 31, 2002, which was a continuation of original Australian patent application Serial No. PR 8601, which was filed on Oct. 31, 2001.

### FIELD OF THE INVENTION

The present invention relates to a system and method of dissemination recorded audio information.

### DESCRIPTION OF THE PRIOR ART

It is known for a public figure, or other new maker, to provide information to reporters, or any other news providers, for distribution to the public in the form of a media release. The public figure might present the media release orally before a gallery of reporters, or provide the media release as a text document for reporters.

In the event that the public figure presents the media release orally, reporters capture the presentation using any suitable audio or video recording device for later dissemination over a radio or television network. In order to record the audio portion of such a presentation, the reporter must be at the location where the media release is presented and be close enough to the public figure to be able to clearly record his/her voice. When there are large numbers of reporters in the gallery, each vying for the best position to record the public figures voice, the task of making a quality recording becomes difficult. In order to record the video portion of such a presentation, the reporter must position a video camera to obtain clear, uninterrupted, view of the public figure. When the gallery of reporters is large, it might be difficult to position a video camera in such a position. As such, it might be difficult to record the audio/video presentation of the media release that is of an acceptable quality for broadcasting on a radio or television network.

Typically, the public figure does not have an opportunity to correct any error in the information or flaw in the presentation of the media release once he/she has made the presentation. Further, the public figure is not generally able to control when the reporters disseminate the presentation of the media release.

If a reporter missed the presentation of the media release, that reporter might have missed their opportunity to broadcast that media release to the public unless he/she can obtain a copy of the media release from a fellow reporter.

Alternatively, the public figure, or any other new maker, might provide a media release in the form of a text document for reporters, or any other new providers, for distribution to the public. Upon receipt of such a document, a reporter might prepare and present the media release to the public by printing the information in a newspaper, posting the information on the Internet, or broadcasting the information over a radio or television network. The reporter who receives the text version of the media release might attempt to contact the public figure to whom the media release pertains an request a recitation of a quotable portion of the media release for broadcasting to the public. If the public figure agrees to provide such a quote, the public figure might read the quotable portion of the media release over a telephone to the reporter while the reporter records the audio of the recitation.

The public figure might err in their recitation and might not be given an opportunity to rerecord the quote by the reporter. As such, a less than desirable quote from the public figure might be released to the public by the reporter. Once the reporter has the quote from the public figure, the public figure might not be able to control when his/her quote will be released to the public. Further, such recordings, typically made over mobile or dedicated telephone networks, might not be of an standard that is suitable for broadcasting to the public.

It is an object of the present invention to overcome one or more of the above-mentioned problems, or at lease provide a useful alternative.

### SUMMARY OF THE INVENTION

In accordance with the invention there is provided a method of dissemination recorded information spoken by a first person, including the steps of:

a) recording at least audio information at a first location, thereby creating recorded information;

b) generating a bibliographic tag which is associated with the recorded information and includes an identifier;

c) transmitting the recorded information and the bibliographic tag to a second location; and

d) storing the recorded information and the bibliographic tag at said second location for selective access by further persons from respective further locations.

The method of dissemination recorded information can include the bibliographic tag including a conditional access means substantially determining a condition which upon such being fulfilled allows said selective access. The condition could include a time after which selective access is to be allowed. The condition could include an authorization of any editing of the information on behalf of the first person. In another form or in combination the condition including a geographical limitation on the further locations from which further persons can obtain selective access. The condition could also or instead include an authorization of the further persons to obtain selective access.

The method of dissemination recorded information can include the steps of requesting a key from the second location and receiving a key from the second location before said step of recording, with the key forming part of said bibliographic tag.

The recorded information can be a recitation of text information and said step of transmitting includes transmitting the text information to the second location and said step of storing includes storing the text information at the second location for selective access by further persons from respective further locations. Preferably the recorded information being of audio or video general broad cast quality. The recorded information includes recorded audio information or corresponding recorded video information.

The method of disseminating recorded information can have the identifier including a searchable subject mater identifier for review by the further persons allowed selective access. The identifier including a searchable subject mater identifier for review by the further persons allowed selective access.

The bibliographic tag can include an address of the second location to enable ready transmittal of the recorded information to the second address. In one form the recorded information is undertake on a recording machine attachable to a public communications network wherein upon the recording being completed the recorded information is automatically transmitted over the public communications network to the second location for selective access by further persons a further locations. The method of dissemination recorded information has the bibliographic tag including an address of the second location to enable ready transmittal of the recorded information to the second address. The recorded information can be undertake on a recording machine attachable to a public communications network wherein upon the recording being completed the recorded information is automatically transmitted over the public communications network to the second location for selective access by further persons at further locations.

According to one aspect of the present invention, there is provided a method of dissemination recorded audio information spoken by a first person, including the steps of:

a) recording the audio information at a first location, thereby crating recorded audio information;

b) generating a bibliographic tag;

d) transmitting the recorded audio information and the bibliographic tag to a second location; and

d) storing the recorded audio information the bibliographic tag at said second location for selective access by further persons from respective further locations.

The bibliographic tag can substantially determine when said selective access can occur.

The method can include the steps of requesting a key from the second location and receiving a key from the second location before said step of recording, wherein the key forms part of said bibliographic tag.

The recorded information can be the recitation of text information and said step of transmitting includes transmitting the text information to the second location and said step of storing includes storing the text information at the second location for selective access by further persons from respective further locations.

The recorded information can be of broadcast quality.

In one form of the invention, the recorded audio information includes corresponding recorded video information.

The present invention also provides a method of issuing a media release including:

a) recording a quote spoken by a person as audio data;

b) generating a bibliographic tag for said audio data;

d) Storing a media release including said audio data and said bibliographic tag for access on a public communications network.

In one form of the invention, the recorded audio information includes corresponding recorded video information.

The novel features that are considered characteristic of the invention are set forth with particularity in the appended claims. The invention itself, however, both as to its structure and its operation together with the additional objects and advantages thereof will best be understood from the following description of the preferred embodiment of the present invention. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments of the invention is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### DESCRIPTION OF THE DRAWINGS

FIG. 1 is a block diagram of a system of disseminating recorded audio information connected to a network;

FIG. 2 is a block diagram of the system;

FIG. 3 is a block diagram of users interacting with the system;

FIG. 4 is a block diagram of steps executed by a news maker module of the system;

FIG. 5 is a block diagram of further steps executed by the news maker module of FIG. 4;

FIG. 6 is a display generated by the news maker module of FIGS. 4 and 5;

FIG. 7 is another display generated by the news maker module of FIGS. 4 and 5;

FIG. 8 is a block diagram of system functions provided for news providers of the system;

FIG. 9 is a block diagram of steps executed by the system for a news provider;

FIG. 10 is a display generated by the system for a news provider;

FIG. 11 is a block diagram of method steps executed for the system administrators of the system;

FIG. 12 is a block diagram of system functions provided for system administrators of the system;

FIG. 13 is a block diagram of the system functions for a news maker provided by one embodiment of the system;

FIG. 14 is a block diagram of method steps executed for a news maker by the system of FIG. 13;

FIG. 15 is a display generated by the system of FIGS. 13 and 14; and

FIG. 16 is a display generated by the system of FIGS. 13, 14, and 15.

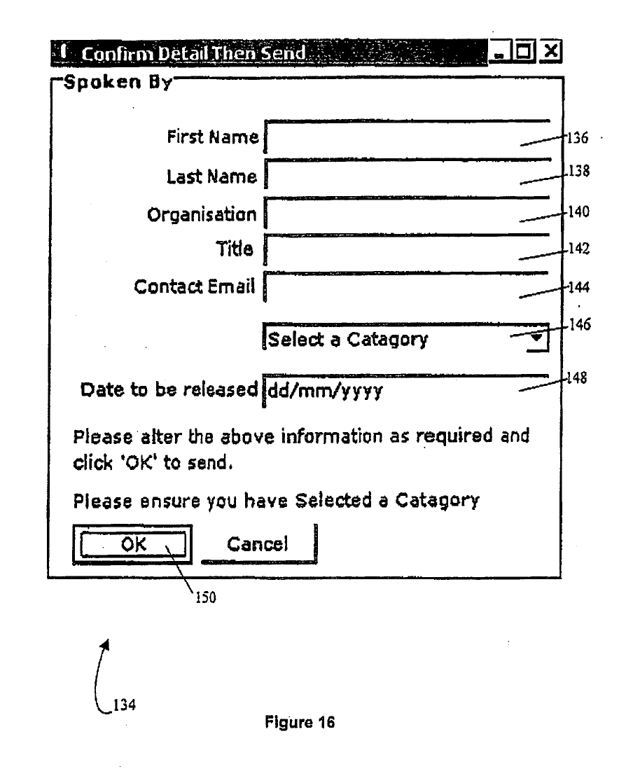

### DESCRIPTION OF THE PREFERRED EMBODIMENTS

While the invention is susceptible to various modifications and alternative constructions, the preferred embodiment is shown in the drawings and will be described below in detail. It should be understood, however, that there is no intention to limit the invention to the specific form disclosed, but, on the contrary, the invention is to cover all modifications, alternative constructions, and equivalents falling within the spirit and the scope of the invention as defined in the claims.

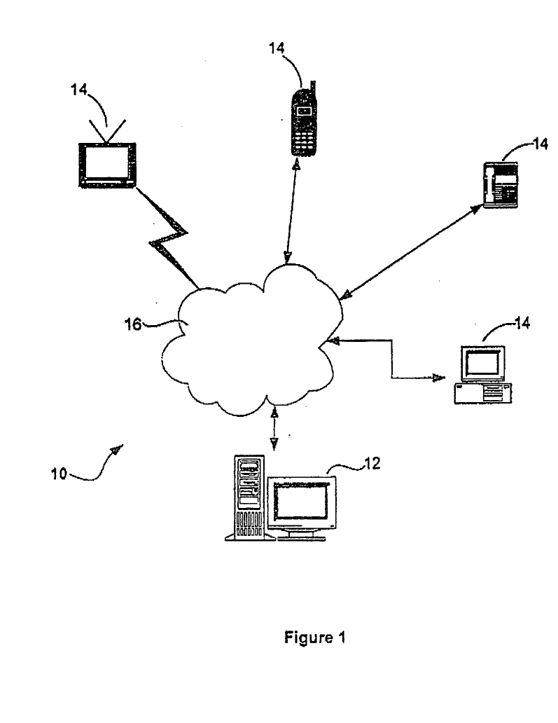

A system 10 of disseminating recorded audio information is provided by a computer system 12 that is able to interact with client terminals 14 of members, or users, of the system 10 over a communications network 16 using standard communications protocols, as shown in FIG. 1.

The terminals 14 of the members might be a wide variety of communications devices, such as a computer, a telephone or an interactive television. The communications network 16 might include the Internet, telecommunications networks and/or local area networks. The components of the system 10 can be configured in a variety of ways. The components might be implemented entirely by software to be executed entirely on standard computer server hardware, which might comprise one hardware unit or different computer hardware units distributed over various locations, some of which might require the communications network 16 for communication. A number of the components or parts thereof might also be implemented by application specific integrated circuits (ASICs). It will be apparent from the description of the system 10 and its operation below, that the most practical implementation of the components of the computer system 12 is a software implementation. Alternative methods of providing system displays and information can also be used, for example WML pages for mobile telephones, and interactive voice response (IVR) systems for connection to standard fixed telephones or voice over IP terminals.

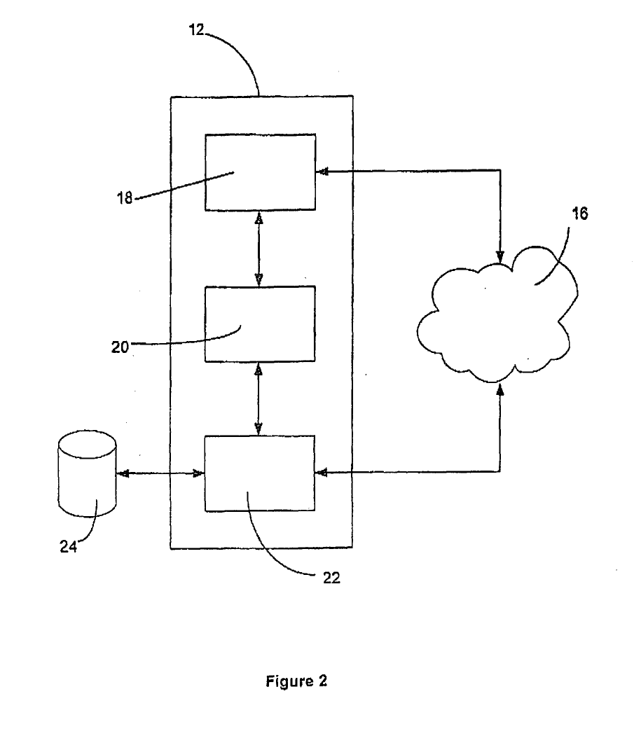

The computer system 12 includes a web server 18, a transaction engine 20, a database server 22 and a database 24 as shown in FIG. 2. The web server 18 is software stored on the computer system 12 that allows the computer system 12 to serve static and dynamic web pages. The web server 18 allows members of the system 10 to access web pages crated and stored on the computer system 12 via their respective terminals 14. The web pages published by the web server 18 are dynamic and are populated by data provided by the transaction engine 20 of the computer system 12.

The database server 22 is software stored on the computer system 12 that allows the computer system 12 to manage the database 24. The database server 22 reads, writes, maintains and secures data on the database 24. The database server 22 maintains data in the database 24 for all members of the system 10. The database 24 is maintained preferably on hard disk storage of the computer system 12.

The transaction engine 20 is software that processes data received by the web server 18 for users of the system 10 via their terminals 14 and is able to retrieve and store data on the database 24 via the database server 22. The transaction engine 20 communicates with the web server 18 and database server 22 to execute data transactions for the system 10 and thereby provides dynamic content for the web pages provided by the web server 18.

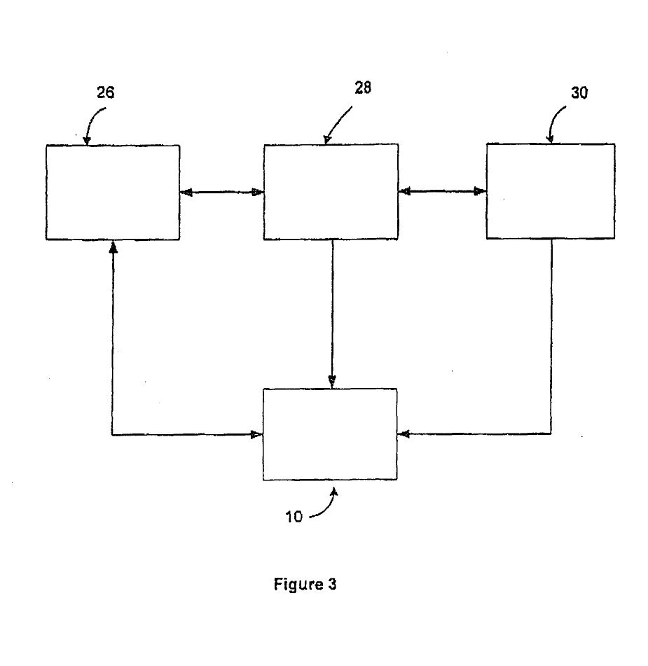

There are three distinct groups of members or users of the system 10, news makers 26, system administrators 28 and news providers 30 who interact with the system 10 via their equipment 14, as shown in FIG. 3. A news maker 26 is a person who creates news for the public. A system administrator 28 is a person who maintains the computer system 12 and who interacts with both news makers 26 and news providers 30. A news provider 30 is a person who distributes information to the public.

In order to use the system 10, a news maker 26 first subscribes to the system 10. A news maker 26 might subscribe to the system 10 by calling a system administrator 28 using a telephone 14 and making a formal request to be a member of the system 10. The system administrator 28 will request details from the news maker 26 in order to establish an account for the news maker 26 on the computer system 12. The system administrator 28 can either enter these details directly into the computer system 12 or from a remote computer 14 that is able to establish a secure communications connection with the computer system 12. Once an account has been established for a news maker 26, the system administrator 28 sends the news maker 26 a start-up kit containing a microphone, a set of headphones and a copy of a news maker module.

Alternatively, to subscribe to the system 10 over the Internet, a news maker 26 uses his/her computer 14 to establish a communications connection with an Internet service provider and then uses a web browser on their computer 14 to access the computer system's web site. The splash page for the system's web site includes a function button for subscribing to the system 10. The news maker 26 executes the subscription function button and the web server 18 generates a subscription page for the new maker 26. The subscription page prompts the news maker 26 for various details so that the computer system 12 can set up an account for the new maker 26. The transaction engine 20 obtains these details and stores them on the database 24. On completion of entry of these details, the web server 18 prompts the news maker 26 to either down load a copy of the news maker module or to submit a quest to a system administrator 28 for a start-up kit to be posted to them.

Each news maker module is an executable software program with a unique serial number. Each news maker 26 who subscribes to the system 10 can therefore be identified by the serial number of their news maker module.

A news maker 26 installs the executable news maker module on his/her computer 14 from either the CD that was posted to them or from the copy that was downloaded by them from the system's web site. Once the news maker module has been installed, the news maker 26 connects a microphone and a headphone set to his/her computer 14 and loads the news maker module.

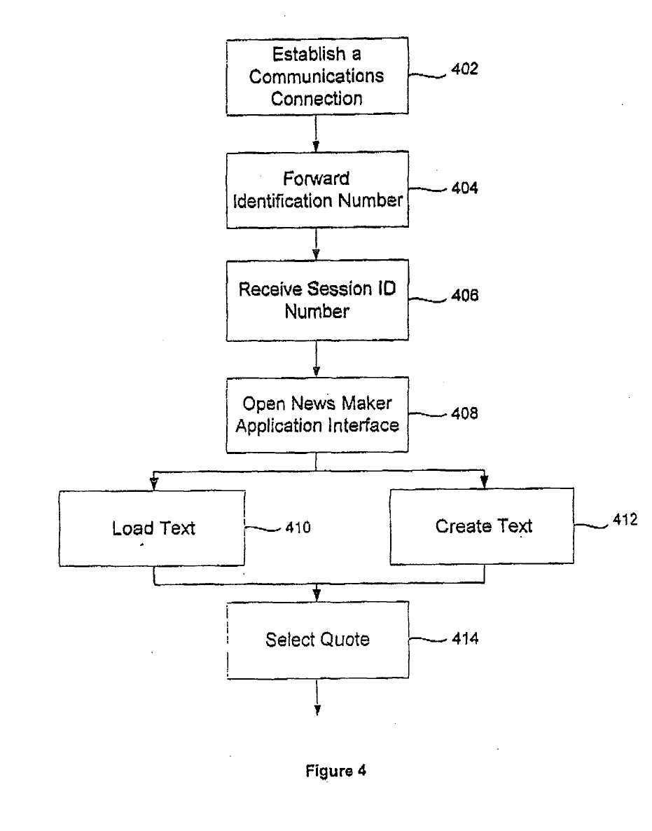

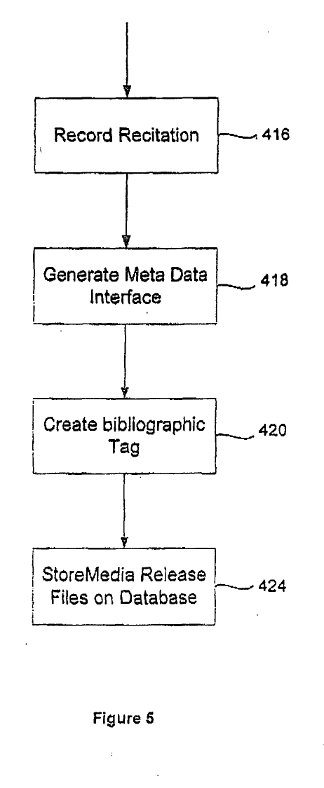

When the news maker module is loaded, it executes the steps shown in FIGS. 4 and 5. The news maker module establishes a communications connection between the news maker's computer 14 and the computer system 12 via the computer's modem (step 402) and forwards identification information, which includes the news maker module's serial number, to the computer system 12 (step 404). The computer system 12 receives the identification information, confirms that the information is correct and returns a session identification number to the news maker module (step 406).

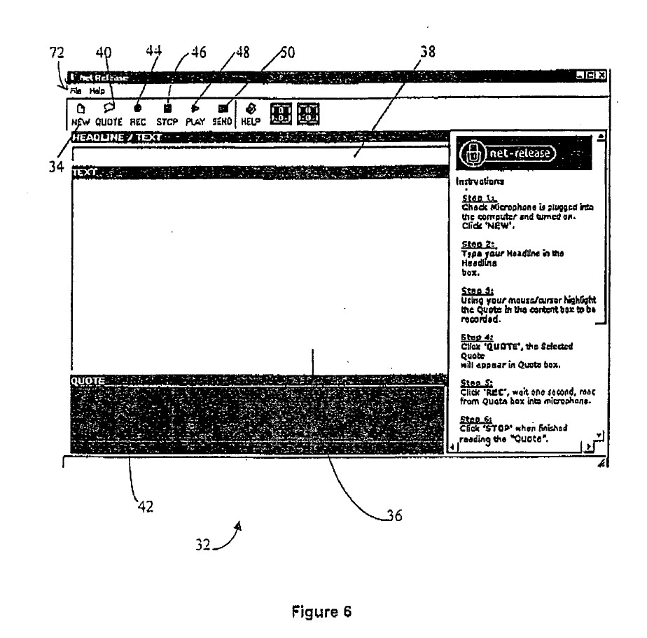

Upon receipt of the session identification number, the news maker module generates an application interface 32 for the news maker 26 (step 408), as shown in FIG. 6. The news maker 26 begins a recording session by clicking on the “NEW” function button 34 on the application interface 32 with the computer's mouse. Upon execution of the “NEW” function button 34, the news maker module deletes all temporary files stored in a predetermined temporary file storage area in the memory of the news maker's computer 14 and prompts the news maker 26 to choose between loading a text document (step 410) from a text file into “TEXT” and “HEADLINE” data fields 36, 38 on the application interface 32 or manually entering text (step 412) these date fields 36, 38.

The “TEXT” and “HEADLINE” data fields 36, 38 of the application interface 32 are empty if manual entry of text is selected by the news maker 26 and the news maker module allows the news maker 26 to create text in these data fields 36, 38.

With the “TEXT” and “HEADLINE” date fields 36, 38 filled with text the news maker 26 scrolls through the text in the “TEXT” data field 36, identifies a quotable passage and highlights that passage using the computer's mouse or keyboard. By clicking the “QUOTE” function button 40 on the application interface 32, the highlighted text appears in a larger font in the “QUOTE” data field 42 on the application interface 32 (step 414).

With microphone and headphones connected to the news maker's computer 14, the news maker 26 clicks the “REC” function button 44 on the application interface 32 and begins reading the text presented to him/her in the “QUOTE” data field 42 into the microphone. When the “REC” function button 44 is executed, the news maker module deletes all files stored in the temporary file storage area on the news maker's computer 14 and begins to record the news maker's recitation (step 416).

The news maker module samples the news maker's recitation through the microphone and records the news make's recitation until the news maker 26 clicks on the “STOP” function button 46 on the application interface 32. Upon execution of the “STOP” function button 46, the news maker module saves the recitation as a WAV audio file in the temporary file storage area on the news maker's computer 14.

When the “STOP” function button 46 is executed, the news maker module makes a “PLAY” function button 48 on the application interface 32 available for use by the news maker 26. When executed, the “PLAY” function button 48 plays the WAV audio file for the news maker 26 through the news maker's headphones. The news maker 26 might rerecord the quote by clicking on the “REC” function button 44 a further time. The news maker module saves each new WAV audio file for a quote in the place of any previous WAV audio file in the temporary file storage are for that quote.

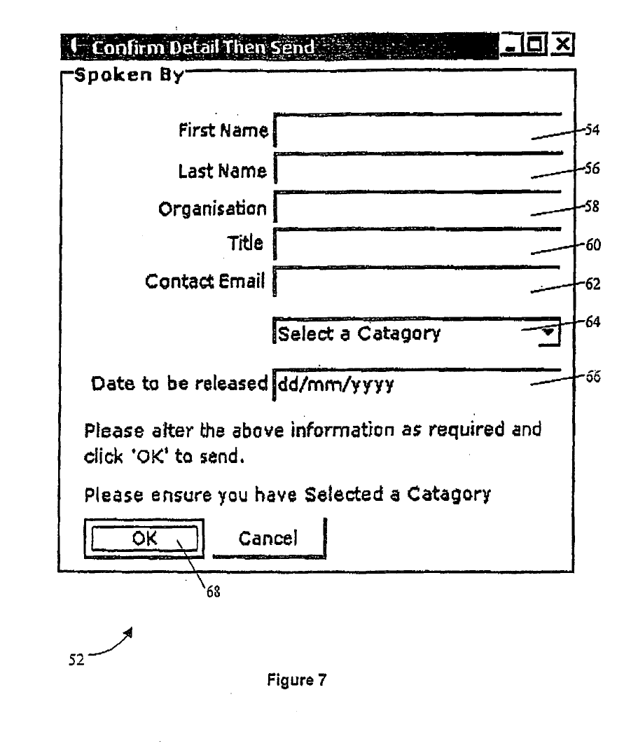

When the news maker 26 has completed recording a recording session the news maker 26 might elect to send the media release, including the text of the media release and WAV audio file, to the computer system 12 by clicking the “SEND” function button 50 on the application interface 32 with the computer's mouse. Upon clicking the “SEND” function button 50, the news maker module generates (at step 418) a meta data interface 52, as shown in FIG. 7.

The meta data interface 52 prompts the news maker 26 to enter the following bibliographic information:

(i) their first and second names in the “First Name” and “Last Name” data fields 54, 56;

(ii) their organization name in the “Organization” data field 58;

(iii) the title of the recording in the “Title” data field 60;

(iv) contact E-mail address in the “Contact E-Mail” data filed 62;

(v) the recording category in the “Select a Category” data field 64; and

(vi) the release date for the media release in the “Date to be Released” data field 66.

The news maker 26 is able to control the date on which the system 10 allows news providers 30 to access the media release by allowing news makers 26 to nominate a media release date in the “Date to be Released” data field 66.

Once this information is entered, the news maker 26 clicks the “OK” function button 68 with the computer's mouse and the news maker module generates (at step 420) a bibliographic tag for the media release from the above bibliographic information (i) to (vi) and establishes a FTP connection with a FTP server, not shown, on the computer system 12.

The news maker module then uploads the following to the computer system 12:

(i) a file including the text of the media release from “TEXT”, “HEADLINE” and “QUOTE” data fields 36, 38, 42;

(ii) a WAV audio file of the recitation;

(iii) a file comprising the bibliographic tag, containing the bibliographic data entered by the news maker 26 using the meta data interface 52;

(iv) the session identificaiotn number; and

(v) the news maker module serial number.

On receipt of this information, the computer system 12 checks whether the information was in order and stores the information on the database 24 via the database server 22 (step 424). The computer system 12 sends a confirmation message to the news maker's computer 14 once this is done.

The news maker module returns the news maker 26 to the application interface 32 once it receives confirmation from the computer system 12. The news maker 26 might then either end the recording session by selecting the close function butter, not shown, from the “FILE” menu button 72 on the application interface 32 or make another recording by clicking the “NEW” function button 34. When the close function button is selected, the news maker module clears the temporary file storage area of the news maker's computer 14, logs out of the computer system 12 and closes the application interface 32.

The computer system 12 allows news providers 30 to access its web site and download a media release that includes the text of the media release, a WAV audio file of a quote from the text of the media release and a bibliographic tag. In order for a news provider 30 to use the system, a news provider 30 subscribes to the system 10. A news provider 30 might subscribe to the system 10 by either contacting a system administrator 28 using a telephone or by visiting the system's web site.

To subscribe to the system 10 by telephone 14, a news provider 30 calls a system administrator 30 and makes a formal request to be a member of the system 10. The system administrator 28 will request details from the news provider 30 in order to establish an account and user profile for the news provider 30 on the computer system 12. The system administrator 28 can either enter these details directly into the computer system 12 or from a remote computer 14 that is able to establish a secure communications connection with the computer system 12.

Alternatively, to subscribe to the system 10 over the Internet, a news provider 30 uses his/her computer 14 to establish a communications connection with an Internet service provider and a web browser, installed on their computer 14, to accesses the system's web site. The splash page for the system's web site includes a function button for subscribing to the system 10. The news provider 30 executes the subscription function button and the web server 18 generates a subscription page for the news provider 30. The subscription page prompts the news provider 30 for various details and once these details are entered the computer system 12 generates an account for the news provider 30. The web server 18 stores these details on the database 24. On successful entry of these details, the computer system 12 prompts the news provider 30 to nominate a login name and password to be associated with their account and stored on the database 24.

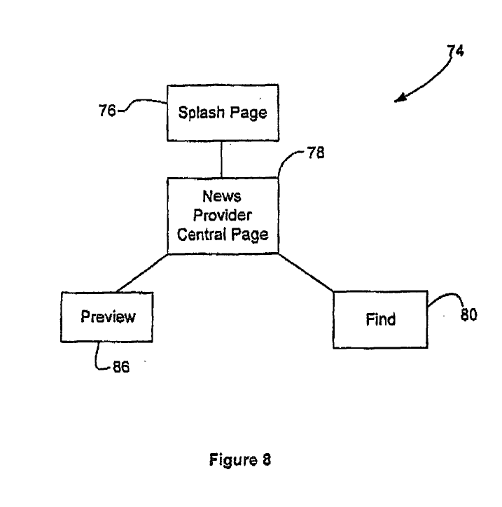

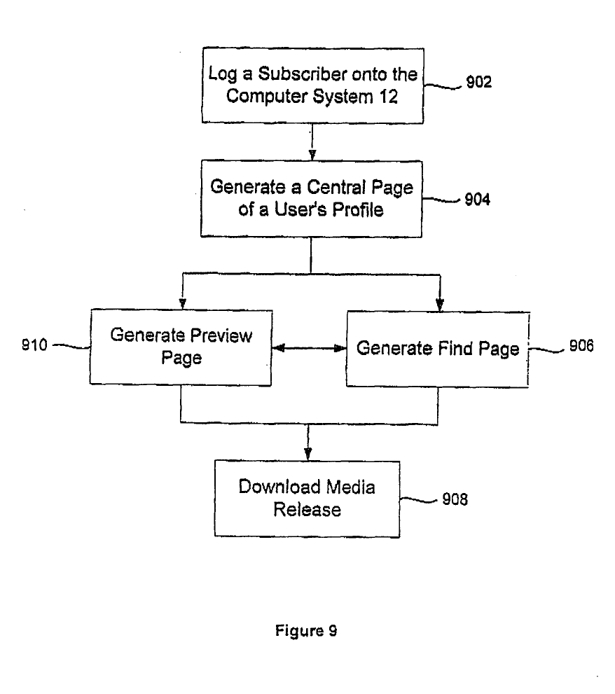

The registration details of each news provider 30 are stored on the database 24 and these details, together with other data stored on the database 24, are used to populate pages generated by the web server 18. The collection of pages, populated with data pertaining to the registered news provider 30, form a profile 74 for a news provider 30 as shown in FIG. 8. A news provider's profile 74 might simply comprise dynamic page scripts, such as ASP scripts, or might include additional code to invoke software modules accessible from the news provider's profile 74. The computer system 12 includes a module to execute the steps shown in FIG. 9 for a news provider 30. Preferably, the module is stored on hard disk storage on the computer system 12.

A news provider 30 who has registered with the system 10 can access their profile 74 by entering their user name and password at the splash page 76 of the system 10 (step 902). On successful entry of these details the module generates the central page 78 of the news provider's profile 74 (step 904). A news provider's profile 74 includes a central page 78 from which a new's provider 30 can search for a media release by executing a “FIND” function button, not shown, and preview a media release by executing a “PREVIEW” function button, also not shown.

A news provider 30 searches for a particular media release by executing the “FIND” function button on the central page 78. Upon execution of the “FIND” function button, the web server 18 generates (at step 906) a “FIND” page 80 for the news provider 30. The “FIND” page 80 prompts the news provider 30 to enter details pertaining to a particular media release. The computer system 12 then searches the database 24 to find the files associated with that media release. If the computer system 12 was able to match the search information with a particular media release, the computer system 12 then determines whether the relevant news provider 30 has permission to access the media release and whether the release date of the media release is equal to or less than the present date.

If the news provider 30 is not granted permission to access the media release because the current-date is less than the release date, then the computer system asks the news provider 30 whether they wish to be notified when the media release is accessible. If the new provider 30 elects to be notified, the computer system 12 will prompt the news provider 30 to nominate their preferred method of notification. The computer system 12 stores this information on the database 24 and on the relevant release date the computer system 12 notifies the relevant news providers 30 that the media release is accessible.

If the news provider 30 is granted permission to access the media release, the “FIND” page will indicate that the following information is available:

(i) a text file of the media release;

(ii) a WAV audio file of a quote from the media release; and

(iii)a file comprising the bibliographic tag containing the bibliographic data entered by the relevant news maker 26.

The news provider 30 might either preview the media release by executing the “PREVIEW” function button, not shown, on the “FIND” page 80 or download the media release by executing the “DOWNLOAD” function button, also not shown, on the “FIND” page 80.

If a news provider 30 elects to download the media release by executing the “DOWNLOAD” function button, the computer system 12 downloads (at step 908) the files associated with the media, release onto the news provider's computer 14. The news provider 30 is then free to use the copy of the media release on his/her computer 14 to broadcast the media release to the public.

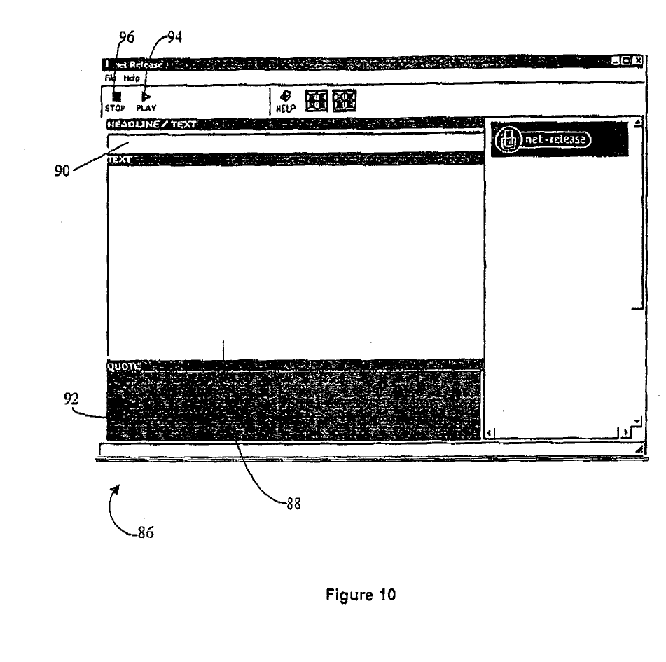

If the news provider 30 elects to preview the media release by executing the “PREVIEW” function button on the “FIND” page 80, the web server 18 generates (at step 910) the “PREVIEW” page 86, shown in FIG. 10, for the news provider 30. The “PREVIEW” page 86 includes “TEXT”, “HEADLINE” and “QUOTE” data fields 88, 90, 92. These data fields 88, 90, 92 are populated with data from the relevant media release when the “PREVIEW” page 86 is generated from the “FIND” page 80 and are otherwise empty.

The PREVIEW” page 86 also includes “PLAY” , “STOP” function buttons 94, 96 and a “DOWNLOAD” function button, not shown. The news provider is able to play the WAV audio file associated with the media release on their computer 14 by executing in the “PLAY” and “STOP” function buttons 94, 96. If the news provider is satisfied with the preview, he/she can download the media release files from the computer system 12 to his/her computer 14 by executing the “DOWNLOAD” function button. When the “DOWNLOAD” function button is executed, the computer system 12 down loads (at step 908) the files associated with the media release onto the news provider's computer 14. The news provider 30 is then free to use the copy of the media release on his/her computer 14 to broadcast the media release to the public.

The news provider 30 is able to preview a media release from the central page 78 by executing the “PREVIEW” function button, not shown. On execution of the “PREVIEW” button from the central page 78 the computer system 12 generates (at step 910) the “PREVIEW” page 86 for the news provider 30. The “PREVIEW” page 86 includes “TEXT”, “HEADLINE” and “QUOTE” data fields 88, 90, 92 that are empty.

The news provider 30 is able to search for a media release to preview by executing the “FIND” function button, not shown, on the “PREVIEW” page 86. The “FIND” function button generates (at step 906) a “FIND” page 80 that functions in the above-described manner.

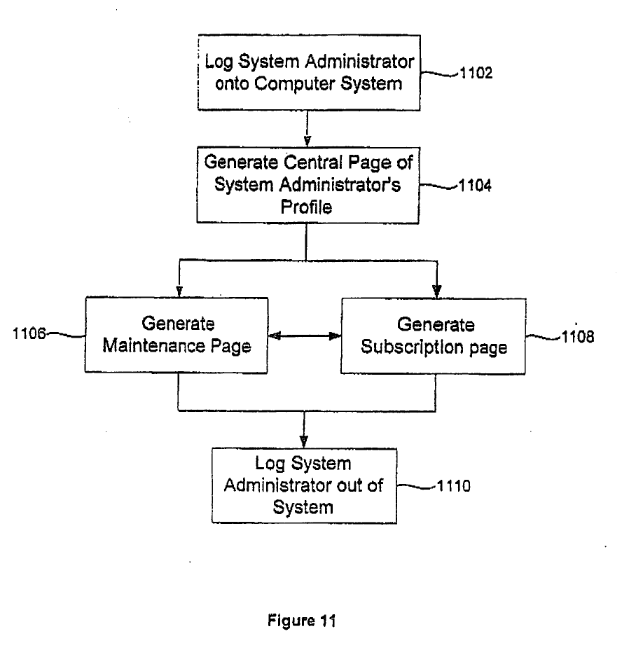

The details of each system administrator 28 are stored on the database 24 and these details, together with other data stored on the database 24, are used to populate pages generated by the computer system 12. The computer system 12 includes a program module to execute the steps shown in FIG. 11 for each system administrator 28. Preferably, the program module is stored on hard disk storage of the computer system 12.

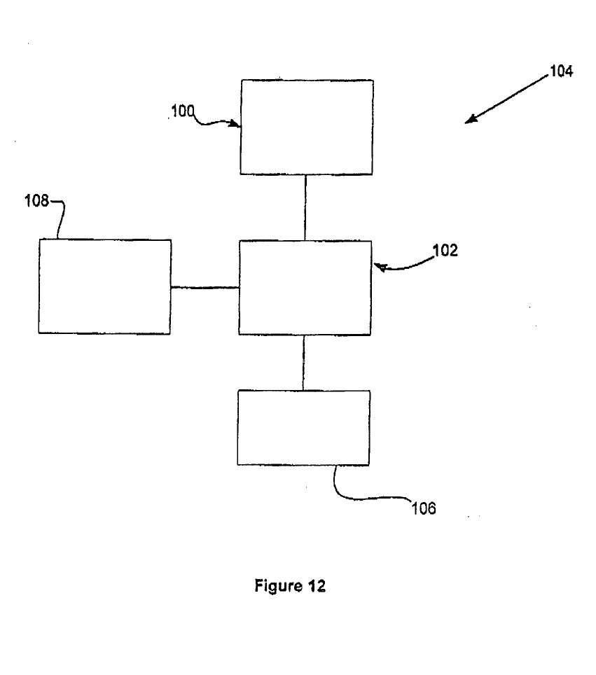

A system administrator 28 interacts with the system 10 by either directly interacting with the computer system 12 or by remote connection to the computer system 12 over a communications network 16. A system administrator 28 logs on to the system 10 (at step 1102) from a login page 100 generated by the program module, by entering their username and password in corresponding data fields, not shown. The computer system 12 checks these details and generates (at step llO4) a central page 102 of a system administrator's profile 104, shown in FIG. 12, if these details are in order.

The central page 102, of a profile 104, includes a “MAINTENANCE” function button, not shown, and a “SUBSCRIPTION” function button, also not shown. The computer system 12 generates (at step 1106) a “MAINTENANCE” page 106 when the system administrator 28 executes the “MAINTENANCE” function button is executed. The “MAINTENANCE” page includes tools to allow the system administrator 28 to regulate the activity of the news makers 28 and the news provider 30 of the system 10 and tools to maintain the system 10.

The computer system 12 generates (at step 1108) a “SUBSCRIPTION” page 108 when a system administrator 28 executes the “SUBSCRIPTION” function button. The “SUBSCRIPTION” page includes tools to allow a system administrator 28 to set up accounts for both news makers 26 and news providers 30.

A system administrator 28 ends a session by logging out of the system 10 (at step 1110).

In one embodiment of the system 10, the news maker module on the news maker's computer 12 establishes an FTP connection with the computer system 12 and uploads the text that is entered by a news maker 26 into the “TEXT” and “HEADLINE” data fields 36, 38 on the news maker's application interface 32, together with the news maker software serial number and the session identification number, to the computer system 12 once a news maker 26 completes entry of the text. This information is received by the computer system 12 and stored on the database 24. Further, once the news maker 26 has finished recording, the news maker module establishes an FTP connection with the computer system 12 and uploads a copy of the WAV audio file, together with the news maker software serial number and the session identification number, to the computer system 12. This information is received by the computer system 12 and stored on the database 24.

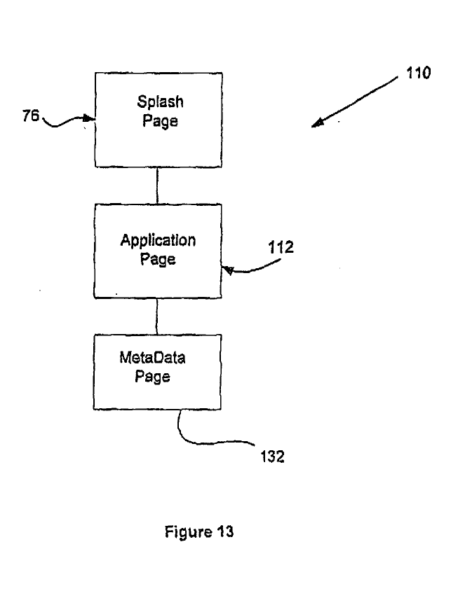

In an alternative embodiment of the invention, a news maker might subscribe to the system 10 by the telephone by calling a system administrator 28 and making a formal request to be a member of the system 10. The system administrator 28 requests details from the news maker 26 so that he/she can form an account for the news maker 26. The system administrator 28 enters these details into the computer system 12, and the computer system 12 generates a profile 110, shown in FIG. 13, for that news maker 26. The news maker 26 nominates a login name and password to the system administrator 28 and, on approval of the login and the password, the system administrator 28 provides the news maker 26 with an identification number. Once the system administrator 28 has entered these details into the computer system 12, the system administrator 28 sends the news maker 26 a start-up kit containing a microphone and a set of head phones.

Alternatively, to subscribe over the Internet, a news maker 26 uses the web browser on his/her computer 14 to accesses the system's web site. The splash page for the system's web site 76 includes a function button to subscribe to the system 10. The news maker 26 executes the subscription function button by clicking the mouse while the mouse cursor is over the subscription function button and the web server 18 generates a subscription page for the news maker 26. The subscription page prompts the news maker 26 for various details and once entry of these details have been entered in to the computer system 12, the web server 18 prompts the news maker 26 to nominate a user name and password. The web server 18 checks that the details are in order and issues the news maker 26 with a unique identification number. Each news maker 26 has a unique identification number and, therefore, each news maker 26 who subscribes to the system 10 can be identified by their identification number.

The registration details of each news maker are stored on the database 24 and these details, together with other data stored on the database 24, are used to populate pages generated by the web server 18. The collection of pages, populated with data pertaining to the registered news maker 26, form a profile 110 for that news maker. A news maker's profile 110 might simply comprise dynamic page scripts, such as ASP scripts, or might include additional code to invoke software modules accessible from the news maker's profile 110.

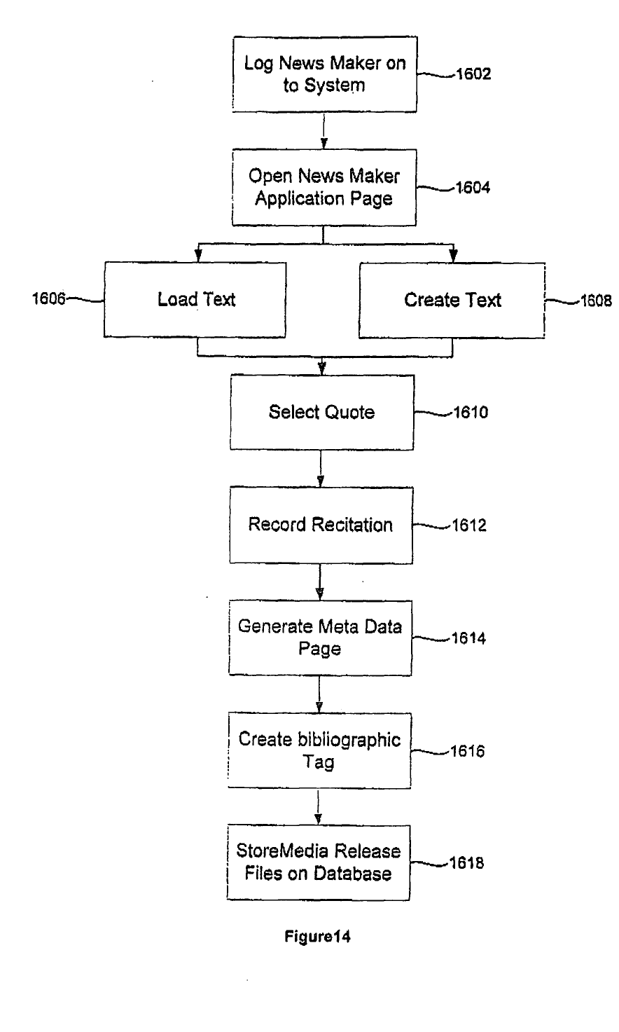

The computer system 12 includes a news maker module that executes the steps shown in FIG. 14 for each news maker 26. Preferably, the news maker module is stored on hard disk storage on the computer system 12.

A news maker 26, who has registered with the system 10 and accordingly has a user name, password and identification number, can access their profile 110 from the home page of the system 10 by entering these details at the splash page 76 of the system 10. The web server 18 receives this information, confirms that the serial number corresponds to a subscriber of the system 10 and allots a session identification number to the news maker 26 (step 1602).

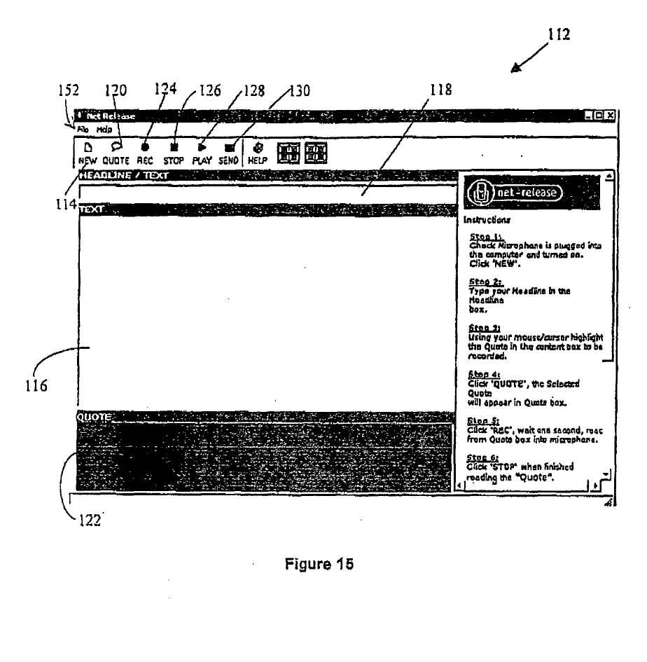

On successful entry into the system 10, the news maker module generates (at step 1604) an application page 112 for the newsmaker 26, as shown in FIG. 15. The news maker 26 begins a recording session by clicking on the “NEW” function button 114 on the application page 112 with the computer's mouse. Upon execution of the “NEW” function button 114, the news maker module deletes all temporary files stored in a predetermined temporary file storage area in the memory of computer system and prompts the news maker 26 to choose between loading (at step 1606) a text document from a text file into “TEXT” and “HEADLINE” data fields 116, 118 on the application page 112 or manually entering text (step 1608) into these data fields 116, 118.

The “TEXT” and “HEADLINE” data fields 116, 118 of the application page 112 are empty if manual entry of text is selected by the news maker 26 and the news maker module allows the news maker 26 to create text in these data fields 116, 118.

With the “TEXT” and “HEADLINE” data fields 116, 118 filled with text, the news maker 26 scrolls through the text in the “TEXT” data field 116, identifies a quotable passage and highlights that passage using the computer's mouse or keyboard. By clicking the “QUOTE” function button 120 on the application page 112, the highlighted text appears in a larger font in a “QUOTE” data field 122 on the application page 112 (step 1610).

With the microphone and headphones connected to the news maker's computer 14, the news maker 26 clicks the “REC” function button 124 on the application page 112 and begins reading the text presented to him/her in the “QUOTE” data field 122 into the microphone. When the “REC” function button 120 is executed, the news maker module deletes all files stored in the temporary file storage and begins to record the news maker's recitation (step 1612).

The news maker module samples the news maker's recitation through the microphone and records the news maker's recitation until the news maker 26 clicks on the “STOP” function button 126 on the application page 112. Upon execution of the “STOP” function button 126, the news maker module saves the recitation as a WAV audio file in the temporary file storage area.

When the “STOP” function button 126 is executed, the news maker module makes a “PLAY” function button 128 on the application page 112 available for use by the news maker 26. When executed, The “PLAY” function button 128 plays the WAV audio file for the news maker 26 through the news maker's headphones. The news maker 26 might rerecord the quote by clicking on the “REC” function button 124 a further time. The news maker module saves the each new WAV audio file for a quote in the place of any previous WAV audio file in the temporary file storage area.

When the news maker 26 has completed recording a recording session, the news maker 26 might elect to permanently store the media release, including the text of the media release and WAV audio file, on the computer system 12 by clicking the “SEND” function button 130 on the application page 112 with the computer's mouse. Upon clicking the “SEND” function button 130, the news maker module generates (at step 1614) a meta data page 134, as shown in FIG. 15.

The meta data page 134 prompts the news maker 26 to enter the following bibliographic information:

(i) their first and second names in the “First Name” and “Last Name” data fields 136, 138;

(ii) their organization name in the “Organization” data field 140;

(iii) the title of the recording in the “Title” data field 142;

(iv) contact E-mail address in the “Contact E-mail” data filed 144;

(v) the recording category in the “Select a Category” data field 146; and

vi) the release date for the media release in the “Date to be Released” data field 148.

The news maker 26 is able to control the date on which the system 10 allows news providers 30 to access the media release by allowing news makers 26 to nominate a media release date in the “Date to be Released” data field 148.

Once this information is entered, the news maker 26 clicks the “OK” function button 150 with the computer s mouse and the news maker module generates (at step 1616) a bibliographic tag for the media release from the above bibliographic information (i) to(vi) and stores (step 1618) the following information on the database 24 via the database server 22:

(i) a file including the text of the media release from “TEXT”, “HEADLINE” and “QUOTE” data fields 36, 38, 42;

(ii) a WAV audio file of the recitation;

(iii) a file comprising the bibliographic tag, containing the bibliographic data entered by the news maker 26 using the meta data page 52;

(iv) the session identification number; and

(v) the news maker identification number.

The computer system 12 sends a confirmation message to the news maker 26 once this is done.

The news maker module returns the news maker 26 to the application page once it receives confirmation from the computer system 12. The new maker 26 might then either end the recording session by selecting the close function button, not shown, from the “FILE” menu button 152 on the application page 112 or make another recording by clicking the “NEW” Function button 114. When the close function button is selected, the news maker module clears the temporary file storage area, logs out the news maker out of the system 10 and closes the application page 112.

In preferred embodiments of the invention, the WAV audio file created by the system 10 is an MPEG audio file or any other suitable audio file.

In preferred embodiments of the invention, the system 10 allows news makers 26 to record audio and video information and the system 10 allows news providers 30 to access the audio and video information recorded by a news maker 26 using the above described techniques.

The preferred embodiment of the invention is described above in the Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

1. A method of disseminating recorded information spoken by a first person, including the steps of:
(a)recording at least audio information at a first location, thereby creating recorded information;
(b) generating a bibliographic tag which is associated with the recorded information and includes an identifier;
(c) transmitting the recorded information and the bibliographic tag to a second location; and
(d) storing the recorded information and the bibliographic tag at said second location for selective access by further persons from respective further locations.

2. The method of disseminating recorded information according to claim 1 with the bibliographic tag including a conditional access means substantially determining a condition which upon such being filled allows said selective access.

3. The method of disseminating recorded information according to claim 2 with the condition including a time after which selective access is to be allowed.

4. The method of disseminating recorded information according to claim 2 with the condition including an authorization of any editing of the information on behalf of the first person.

5. The method of disseminating recorded information according to claim 2 with the condition including a geographical limitation on the further locations from which further persons can obtain selective access.

6. The method of disseminating recorded information according to claim 2 with the condition including an authorization of the further persons to obtain selective access.

7. The method of disseminating recorded information according to claim 1 including the steps of requesting a key from the second location and receiving a key from the second location before said step of recording, with the key forming part of said bibliographic tag.

8. The method of disseminating recorded information according to claim 1 with the recorded information being a recitation of text information and said step of transmitting includes transmitting the text information to the second location and said step of storing includes storing the text information at the second location for selective access by further persons from respective further locations.

9. The method of disseminating recorded information according to claim 1 with the recorded information being of audio or video general broadcast quality.

10. The method of disseminating recorded information according to claim 1 with the recorded information including recorded audio information and corresponding recorded video information.

11. The method of disseminating recorded information according to claim 1 with the identifier including a searchable subject matter identifier for review by the furtherpersons allowed selective access.

12. The method of disseminating recorded information according to claim 1 with the bibliographic tag including an address of the second location to enable ready transmittal of the recorded information to the second address.

13. The method of disseminating recorded information according to claim 12 with the recorded information being undertaken on a recording machine attachable to a public communications network wherein upon the recording being completed the recorded information is automatically transmitted over the public communications network to the second location for selective access by further persons at further locations.

14. The method of disseminating recorded information according to claim 2 with the identifier including a searchable subject matter identifier for review by the further persons allowed selective access.

15. The method of disseminating recorded information according to claim 2 with the bibliographic tag including an address of the second location to enable ready transmittal of the recorded information to the second address.

16. The method of disseminating recorded information according to claim 15 with the recorded information being undertaken on a recording machine attachable to a public communications network wherein upon the recording being completed the recorded information is automatically transmitted over the public communications network to the second location for selective access by further persons at further locations.

17. A method of issuing a media release including:
(a) recording a quote spoken by a person as audio data;
(b) generating a bibliographic tag including identifier for said audio data
(c) storing a media release including said audio data and said bibliographic tag for access on a public communications network.

18. The method of issuing a media release according to claim 17 with the bibliographic tag including data relating to a condition controlling access to said audio data.

19. The method of issuing a media release according to claim 17 with the condition being a time after which selective access is allowed.

20. The method of issuing a media release according to claim 17 with the condition being an authorization following editing of the audio information on behalf of the first person after which selective access is allowed.

21. A computer program product for use with audio and/or video input means by a first person in enabling said first person to record audio and/or video information and to provide a bibliographic tag associated with said recorded information which is searchable and/or enables controlling of selective access to the recorded information when stored on a storage means until a defined condition is achieved such as time, or required access, or indicator of edited or approved condition of recorded information, or geographic condition, or authorized receiver condition.

22. A computer program product according to claim 21 for use with audio and/or video input means and a recording means attachable to a public communications network with the program providing an address means of the storage means at a second location able to be in communication with the recording means over the public communications network and providing control means for substantially allowing automatic transmission of the recorded information with the bibliographic tag and defined condition to the storage means at the second location.

23. A system of disseminating recorded audio information spoken by a first person, including:
(a) means for recording the audio information at a first location, thereby creating recorded audio information;
(b) means for generating a bibliographic tag;
(c) means for transmitting the recorded audio information and the bibliographic tag to a second location; and
(d) means for storing the recorded audio information and the bibliographic tag at said second location for selective access by further persons from respective further locations.

24. The system of disseminating recorded audio information spoken by a first person according to claim 23 with the bibliographic tag substantially determining when said selective access can occur.

25. The system according to claim 23 including means for requesting a key from the second location and receiving a key from the second location before the means for recording can be effected, with the key forming part of said bibliographic tag.

26. A system of disseminating audio information with the recorded information being the recitation of text information including:
means for recording audio recitation of text information;
means for transmitting including means for transmitting the recitation of the text information to the second location;
means at said second location for storing including means for transmitting the recitation of the text information at the second location for selective access by further persons from respective further locations;
a computer system that is able to interact between the means at said second location and with client terminals of members, or users, of the system at said further locations over a communications network using standard communications protocols;
the client terminals of the members, or users including one of a variety of communications devices, such as a computer, a telephone, an interactive television, or the Internet with one or more being over telecommunications networks and/or local area networks;
wherein the client or user can request from the client terminal being a computer, a telephone, an interactive television, or the Internet one of said audio recitation of text information and receive said in audio broadcast mode on said client terminal.
